(19) United States
(12) Patent Application Publication
(10) Pub. No.: US 2014/0192818 A1
(43) Pub. Date: Jul. 10, 2014

(54) NETWORK CONNECTION METHOD CAPABLE OF ANALYZING DATA PACKETS IN ORDER TO SELECT CONNECTION ROUTES

(71) Applicant: D-LINK CORPORATION, Taipei City (TW)

(72) Inventors: Jun-Hao HUANG, Taipei City (TW); Wei-Chung HSU, Taipei City (TW); Ming-Han LIU, Taipei City (TW)

(73) Assignee: D-LINK CORPORATION, Taipei City (TW)

(21) Appl. No.: 13/798,313

(22) Filed: Mar. 13, 2013

(30) Foreign Application Priority Data
Jan. 8, 2013 (TW) 102100516

(51) Int. Cl. H04L 12/56

(52) U.S. Cl. CPC H04L 45/306
USPC 370/401; 370/389

(57) ABSTRACT

The present invention is to provide a network connection method applicable to a network system including a client device and a plurality of source devices, wherein the client device is connected to the Internet through a first connection route (e.g., a power-line network or a cable network) and a second connection route (e.g., a WiFi wireless network) respectively so as to establish a connection channel with each source device, and the client device is able to analyze a data packet received from the source device to determine whether the data packet contains highly delay-sensitive data (e.g., audio/video data and communication data) or delay-insensitive data (e.g., webpage data). When it is determined that the data packet contains highly delay-sensitive data, the data packet is transmitted to the client device through the first connection route which is more stable than the second connection route, otherwise, through the second connection route instead.

### FIELD OF THE INVENTION

The present invention relates to a network connection method, more particularly to a network connection method capable of enabling a client device to analyze a data packet received from a source device through the Internet, to determine whether the data packet contains highly delay-sensitive data (e.g., audio/video data and communication data) or delay-insensitive data (e.g., webpage data), and to select a corresponding connection route to transmit the data packet to the client device, so as to ensure the stability of transmission of high delay-sensitive data.

### BACKGROUND OF THE INVENTION

With continuous improvements in technology, the Internet has become an indispensable tool in people's daily lives. As a global network system, the Internet makes it easier to communicate with one another, to look for locations on maps, to search for stores, and to share entertainment information, to say only a few examples of Internet services. Conventionally, one who wishes to connect a computer to the Internet must connect the computer to a router by means of an Ethernet cable, so that data in the Internet can be transmitted to the computer through the router. Nowadays, thanks to the rapid development of network technologies and mobile devices, the connection between a computer and a router can be made through many other connection routes than the traditional Ethernet cable, such as a WiFi wireless network, a power-line network, and a coaxial cable (e.g., a Multimedia over Coax Alliance cable).

The aforementioned connection routes have their respective pros and cons. An Ethernet cable and a coaxial cable, both of which are physical lines, advantageously feature fast and stable signal transmission typical of such lines. However, difficulties in cable installation make it impractical to connect a computer to a distant router through an Ethernet cable or coaxial cable. A power-line network can transmit signals via existing power lines in a building, but the quality of transmission is related to the age and layout of the power lines. Consequently, power-line networks are limited in use. The now fast-developing WiFi wireless networks can connect routers and computers without using physical lines, have the broadest applications, and are the most flexible in terms of installation. Nevertheless, as wireless signals attenuate significantly when passing through a concrete wall or a human body, interruption in transmission may frequently occur if wireless signals are applied where there are many such barriers. In other words, a WiFi wireless network does not guarantee stable transmission.

Moreover, due to the ongoing explosive increase in the amount of data in the Internet, it is not uncommon that the transmission route between a computer and a router through which the computer, and many others, are connected to the Internet is so jammed with concurrent and excessively large data flows that some data are delayed during transmission. Should certain types of data be delayed, however, the quality of Internet connection will be seriously impaired (e.g., signal transmission will be interrupted during network-based communication, and the playback of an on-line video will be accelerated or decelerated from time to time). In consideration of this, the inventor of the present invention came up with the idea of connecting a computer and a router through plural connection routes so as to increase the bandwidth of data transmission through the router. After studying related technologies, the inventor believes that, if the router can further analyze and screen data and transmit different data through different connection routes respectively, not only will the bandwidth load of the router be substantially reduced, but also the computer can operate with enhanced efficiency while connected to the Internet.

Therefore, the issue to be addressed by the present invention is to improve the way in which a router makes network connection so that, upon receiving data from the Internet, the router analyzes the data first in order to select the connection routes suitable for data transmission.

### BRIEF SUMMARY OF THE INVENTION

In view of the problem that important data may be delayed during transmission between a computer and the Internet due to concurrent transmission of an excessive amount of data, the inventor of the present invention put years of practical experience into extensive research and experiment and finally succeeded in developing a network connection method capable of analyzing data packets and selecting connection routes accordingly. It is hoped that the present invention contributes to the creation of an environment where the use of networks better suits user needs.

It is an object of the present invention to provide a network connection method capable of analyzing data packets in order to select connection routes. The network connection method is applicable to a network system which includes a client device and a plurality of source devices. The client device is connected to the Internet through a first connection route (e.g., a power-line network or a cable network) and a second connection route (e.g., a WiFi wireless network) respectively so as to establish a connection channel with each source device. The client device is provided with a routing table which stores plural entries of source data and plural predetermined routes. Each entry of source data corresponds to a source device to which the client device has established a connection channel before. Each predetermined route represents either the first connection route or the second connection route and corresponds to one of the plural entries of source data. Thus, the client device can select, according to any given entry of source data, the corresponding one of the predetermined routes and transmit data packets to and from the corresponding source device through the corresponding predetermined route. The method includes the following steps to be performed by the client device. To begin with, when the client device receives a data packet from a source device which does not correspond to any of the plural entries of source data, the client device analyzes the data packet to determine whether the data packet contains highly delay-sensitive data (e.g., audio/video data and communication data) or delay-insensitive data (e.g., webpage data). If it is determined that the data packet contains highly delay-sensitive data, the data packet is transmitted to the client device through the first connection route. If it is determined that the data packet contains delay-insensitive data, the data packet is transmitted to the client device through the second connection route instead. Then, the client device adds the network connection data of the source device into the routing table as an entry of source data and records the corresponding connection route as a predetermined route in the routing table. Thus, when the source device subsequently sends a second data packet to the client device, the client device can select the corresponding connection route directly from the routing table and transmit the second data packet through the corresponding connection route. As the client device will transmit through the stabler first connection route any data which are relatively sensitive to transmission delay, not only is the bandwidth load of the client device effectively reduced, but also the stability of transmission of high delay-sensitive data is ensured. Consequently, the efficiency with which the client device operates when connected to the Internet is enhanced.

Another object of the present invention is to provide the foregoing network connection method, wherein the client device includes a client computer and a router. The client computer is connected to the router through the first connection route and the second connection route respectively, and the routing table is stored in the router. According to the method of the present invention, the router analyzes the type code of the data packet. If the type code of the data packet is Data or Background, it is determined that the data packet contains delay-insensitive data. If the type code of the data packet is Video or VoIP, it is determined that the data packet contains highly delay-sensitive data.

Still another object of the present invention is to provide the foregoing network connection method, wherein the router analyzes the transmission protocol of the data packet instead. If the transmission protocol of the data packet is the User Data Protocol (UDP), it is determined that the data packet contains highly delay-sensitive data. If the transmission protocol of the data packet is the Transmission Control Protocol (TCP), it is determined that the data packet contains delay-insensitive data.

### BRIEF DESCRIPTION OF THE SEVERAL VIEWS OF THE DRAWINGS

The present invention will be best understood by referring to the following detailed description of some illustrative embodiments in conjunction with the accompanying drawings, in which:

FIG. 1 schematically shows a network system to which the network connection method of the present invention is applied;

FIG. 2 schematically shows a routing table for use in the network connection method of the present invention;

FIG. 3 is the flowchart of the network connection method of the present invention; and

FIG. 4 schematically shows another network system to which the network connection method of the present invention is applied.

### DETAILED DESCRIPTION OF THE INVENTION

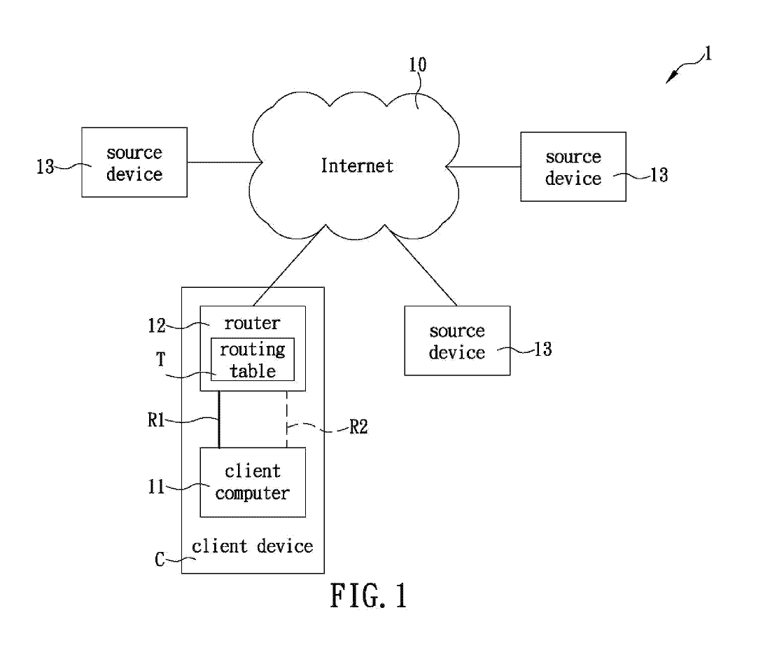

The present invention discloses a network connection method capable of analyzing data packets in order to select connection routes. Referring to FIG. 1 for the first preferred embodiment of the present invention, the network connection method is applied to a network system 1 which includes a client device C and a plurality of source devices 13. The client device C includes a client computer 11 and a router 12. The client computer 11 is connected to the router 12 through at least a first connection route R1 and a second connection route R2 so as to connect to the Internet 10 by way of the router 12. (In FIG. 1, connection for physical transmission is represented by a solid line, and connection for wireless transmission is represented by a dashed line.) In this embodiment, the first connection route R1 is a power-line network, and the second connection route R2 is a wireless network. In other preferred embodiments of the present invention, the client computer 11 may be connected to the router 12 through more than two connection routes. For example, the client computer 11 may be connected to the router 12 simultaneously through four different connection routes, such as a WiFi wireless network, an Ethernet cable, a coaxial cable, and a power line in a power-line network.

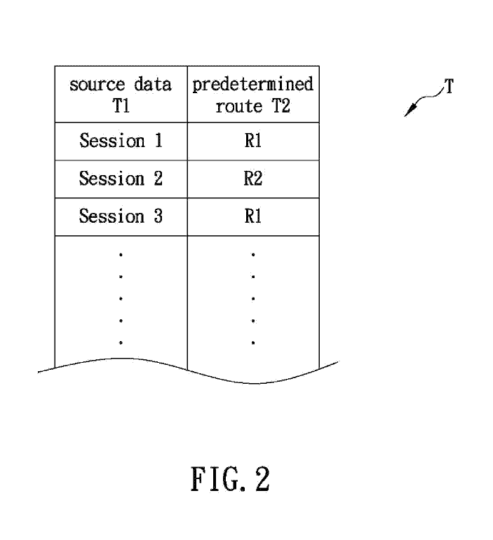

Referring to FIG. 1 and FIG. 2, the router 12 stores a routing table T therein. The routing table T stores plural entries of source data T1 and plural predetermined routes T2. Each entry of source data T1 is an entry of text data or system parameters, such as a session, that represents a source device 13 with which the client computer 11 has established a connection channel before. However, the type of the source data is not a limiting factor of the present invention and may vary, provided that the router can correctly relate each entry of source data to the network connection data (e.g., cookie or IP address) of a source device. Each predetermined route T2 records the transmission mode in which transmission has been carried out between the client computer 11 and a source device 13 before. In other words, each predetermined route T2 represents either the first connection route R1 or the second connection route R2, and each predetermined route T2 further corresponds to one of the plural entries of source data T1, thus allowing the router 12 to select a predetermined route T2 according to the corresponding entry of source data T1 in the routing table T and transmit data between the client computer 11 and the corresponding source device 13 through the selected predetermined route T2. It should be pointed out that the routing table T shown in FIG. 2 is but a schematic drawing intended to enable the examiner and a person skilled in the art to understand the major technical points of the present invention rapidly. In practice, the routing table T may vary slightly in form. FIG. 2 only illustrates the essential features of the routing table T.

The steps by which the router 12 makes network connection according to the network connection method of the present invention are now detailed with reference to FIG. 1 to FIG. 3 as including:

(301) receiving a data packet from a source device 13;

(302) determining whether the source device 13 corresponds to any source data T1 in the routing table T, and performing step (303) if yes and step (304) if no;

(303) finding the predetermined route T2 corresponding to the source data T1 according to the routing table T, transmitting the data packet to the client device C (or more specifically the client computer 11 in this embodiment) through the connection route found, and ending the method;

(304) analyzing the data packet to determine whether the data packet contains highly delay-sensitive data or delay-insensitive data, and performing step (305) if the data packet contains highly delay-sensitive data and step (306) if the data packet contains delay-insensitive data;

(305) transmitting the data packet to the client device C (or more specifically the client computer 11 in this embodiment) through the first connection route R1;

(306) transmitting the data packet to the client device C (or more specifically the client computer 11 in this embodiment) through the second connection route R2; and

(307) updating the routing table T after the data packet is transmitted to the client device C, wherein the update involves adding the network connection information (e.g., the aforesaid session, cookie, or IP address) of the source device 13 into the routing table T as an entry of source data T1, recording the corresponding connection route R1 as a predetermined route T2 in the routing table T, and making this predetermined route T2 correspond to the newly added source data T1.

In this embodiment, referring again to FIG. 1 and FIG. 2, the router 12 will not update the routing table T until the data packet is transmitted to the client computer 11. In other preferred embodiments of the present invention, however, it is feasible for the router 12 to update the routing table T as soon as the router 12 determines the type of the data packet or selects the connection route R1 or R2; in that case, the data packet is transmitted after the update.

Thus, when the source device 13 transmits a second data packet to the router 12 at a later time, the router 12 will follow steps (301) through (303) to find the corresponding predetermined route T2 and transmit the second data packet through the route. The network connection method of the present invention is so designed that the router 12 can automatically determine, through analysis, whether a data packet is highly sensitive to delay in transmission. If yes, the router 12 selects a relatively stable or fast connection route and transmits the data packet therethrough; otherwise, the router 12 selects another transmission route and transmits the data packet therethrough. Now that data packets of different types can be effectively separated, the bandwidth load of the router 12 will be reduced. In consequence, the speed at which and the stability with which the client computer 11 receives and transmits data from and to the Internet 10 will be increased.

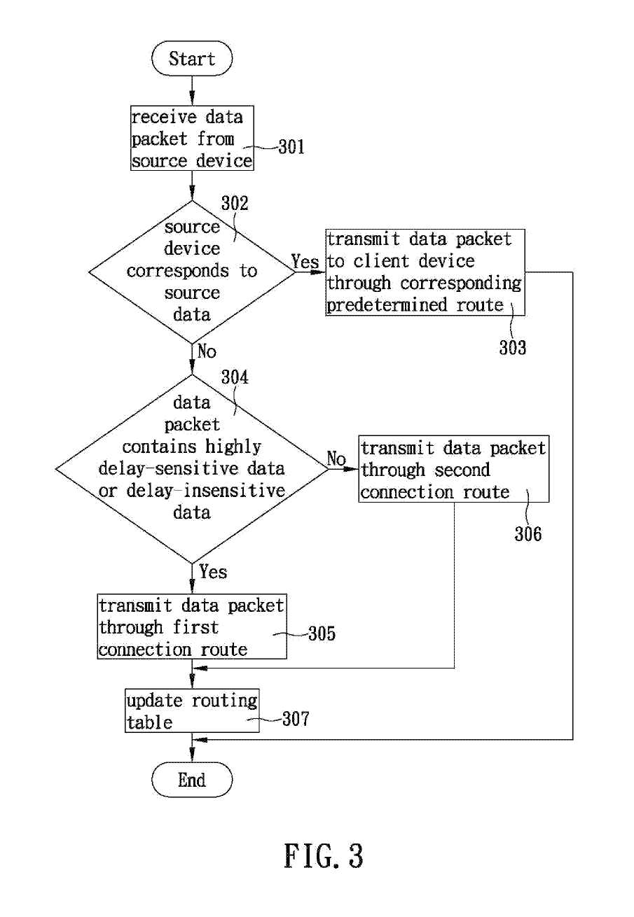

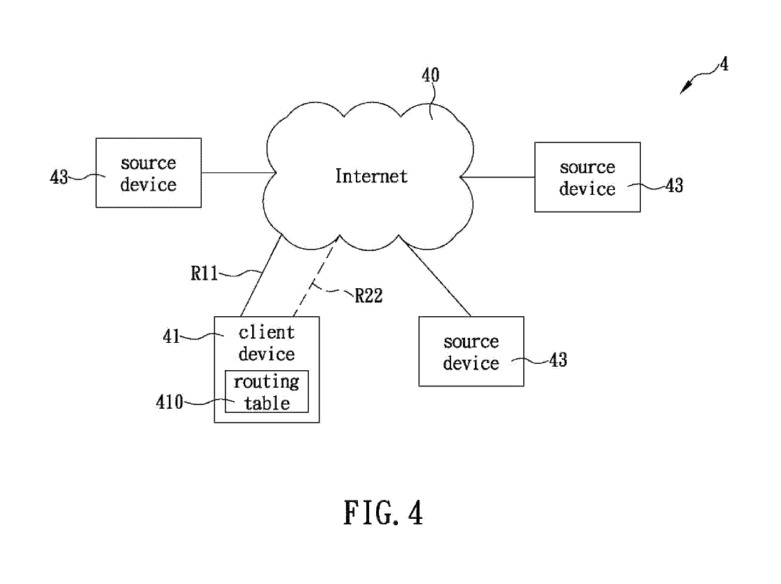

It should be pointed out that, while the network connection method in the foregoing embodiment is applied to the router 12, the network connection method is in fact applicable to any client device C having a network interface, such as a smart phone, a tablet computer, or a laptop computer. Referring to FIG. 4 for another preferred embodiment of the present invention, the network system 4 includes a client device 41 and a plurality of source devices 43. The client device 41 stores a routing table 410 and is connectable to the Internet 40 through the first connection router R11 and the second connection route R22. Therefore, the client device 41 can also execute the network connection method of the present invention according to the steps illustrated in FIG. 3 to achieve the same effects as in the first preferred embodiment.

Referring back to FIG. 1 and FIG. 2, in implementing the first preferred embodiment of the present invention, the router 12 may analyze the data packet based on any desired criterion. Some common applicable analysis and determination methods are presented below by way of example. In the first preferred embodiment of the present invention, the router 12 determines the type of the data packet. If the type code of the data packet is “Data” or “Background”, the data packet contains only general data or background data. If the type code of the data packet is “Video”, “VoIP”, or “Internet Management”, the data packet contains audio/video data, communication data, or managerial data respectively, and should any of such data be delayed during transmission, it is very likely that the entire connection channel will be cut off, causing great inconvenience to the user. Therefore, the data packet, if pertaining to any of the latter types, should be classified as containing highly delay-sensitive data.

If the data packet does not contain any type information, the router 12 may instead analyze the source data T1 of the source device 13 corresponding to the data packet to determine whether the source device 13 is an audio/video service provider website (e.g., YouTube). If yes, meaning the data packet contains audio/video data or communication data, the data packet is directly determined as containing highly delay-sensitive data. In the second preferred embodiment of the present invention, the router 12 may alternatively analyze the transmission protocol of the data packet. If the transmission protocol of the data packet is the User Data Protocol (UDP), the data packet either contains data sensitive to transmission delay or does not have a retransmission mechanism and therefore should be classified as containing highly delay-sensitive data. If the transmission protocol of the data packet is the Transmission Control Protocol (TCP), the data packet either is insensitive to delay in transmission or has a retransmission mechanism and therefore may be classified as containing delay-insensitive data.

It can be known from the above that the present invention is intended to allow highly delay-sensitive data to be transmitted through a connection route with a relatively stable network connection state, thereby providing the user of the client computer with a better user experience. Since a network based on physical lines generally has higher network connection quality than wireless networks, the router 12 may, if connected to the client computer 11 respectively through a physical-line network and a wireless network, directly set the former as the first connection router R1 and the latter as the second connection route R2.

However, all the determination methods described above may need modification, depending on the arrangement, location, and like factors of the client computer 11. Hence, in a further embodiment of the present invention, the router 12 automatically tests the network connection state of each connection route upon startup. For example, in the first preferred embodiment of the present invention, where the router 12 is connected to the client computer 11 through two transmission routes (namely the first connection route R1 and the second connection router R2), the router 12 sends a test packet to the client computer 11 through each of the transmission routes, and the client computer 11 automatically sends a receipt message to the router 12 upon receiving each test packet. The router 12, after obtaining the receipt messages, determines the network connection quality of each transmission route according to the travel time of each receipt message. (For instance, compared with a wireless network, a power-line network typically has a shorter receipt message travel time, which implies a higher network connection speed or stability.) Then, the transmission route with the higher network connection quality (or with the highest network connection quality if there are more than two transmission routes) is set as the first connection route R1, and the transmission route with the lower network connection quality (or with the second highest network connection quality if there are more than two transmission routes) is set as the second connection route R2. The above process ensures the current network connection quality of the first connection route R1 is higher than that of the second connection route R2.

While the invention herein disclosed has been described by means of specific embodiments, numerous modifications and variations could be made thereto by those skilled in the art without departing from the scope of the invention set forth in the claims.

What is claimed is:

1. A network connection method capable of analyzing data packets in order to select connection routes, the network connection method being applicable to a network system comprising a client device and a plurality of source devices, the client device being connected to the Internet respectively through a first connection route and a second connection route so as to establish a connection channel with each said source device, the client device being provided with a routing table, the routing table storing plural entries of source data and plural predetermined routes, each said entry of source data corresponding to a said source device with which the client device has established a said connection channel before, each said predetermined route representing the first connection route or the second connection route and corresponding to a said entry of source data, thus enabling the client device to select, according to a said entry of source data, a corresponding said predetermined route and transmit data packets to and from a corresponding said source device through the corresponding predetermined route, the network connection method comprising the steps, to be performed by the client device, of:
receiving a data packet from a said source device;
analyzing the data packet and determining whether the data packet contains highly delay-sensitive data or delay-insensitive data, upon determining that the source device does not correspond to any said entry of source data in the routing table;
transmitting the data packet to the client device through the first connection route, upon determining that the data packet contains highly delay-sensitive data;
transmitting the data packet to the client device through the second connection route, upon determining that the data packet contains delay-insensitive data; and
adding network connection data of the source device into the routing table as an entry of source data, and recording a corresponding connection route as a predetermined route in the routing table so that, when the source device transmits a second data packet, the client device can directly select from the routing table a corresponding said predetermined route and transmit the second data packet therethrough.

2. The network connection method of claim 1, wherein the client device analyzes a type code of the data packet and determines the data packet as containing delay-insensitive data if the type code of the data packet is Data or Background and as containing highly delay-sensitive data if the type code of the data packet is Video, VoIP, or Internet Management.

3. The network connection method of claim 1, wherein the client device analyzes a transmission protocol of the data packet and determines the data packet as containing highly delay-sensitive data if the transmission protocol of the data packet is the User Data Protocol and as containing delay-insensitive data if the transmission protocol of the data packet is the Transmission Control Protocol.

4. The network connection method of claim 1, wherein the client device analyzes source data corresponding to the data packet and, upon determining that the source device is an audio/video service provider website, identifies the data packet as containing highly delay-sensitive data.

5. The network connection method of claim 1, wherein the client device comprises a client computer and a router, the client computer being connected to the router respectively through the first connection route and the second connection route and thereby connected to the Internet, the routing table being stored in the router.

6. The network connection method of claim 2, wherein the client device comprises a client computer and a router, the client computer being connected to the router respectively through the first connection route and the second connection route and thereby connected to the Internet, the routing table being stored in the router.

7. The network connection method of claim 3, wherein the client device comprises a client computer and a router, the client computer being connected to the router respectively through the first connection route and the second connection route and thereby connected to the Internet, the routing table being stored in the router.

8. The network connection method of claim 4, wherein the client device comprises a client computer and a router, the client computer being connected to the router respectively through the first connection route and the second connection route and thereby connected to the Internet, the routing table being stored in the router.

9. The network connection method of claim 5, wherein the router is connected to the client computer through at least two transmission routes, and the router is configured for testing each said transmission route in order to determine the quality of transmission through each said transmission route and for setting the transmission route with the highest quality of transmission as the first connection route and the transmission route with the second highest quality of transmission as the second connection route.

10. The network connection method of claim 6, wherein the router is connected to the client computer through at least two transmission routes, and the router is configured for testing each said transmission route in order to determine the quality of transmission through each said transmission route and for setting the transmission route with the highest quality of transmission as the first connection route and the transmission route with the second highest quality of transmission as the second connection route.

11. The network connection method of claim 7, wherein the router is connected to the client computer through at least two transmission routes, and the router is configured for testing each said transmission route in order to determine the quality of transmission through each said transmission route and for setting the transmission route with the highest quality of transmission as the first connection route and the transmission route with the second highest quality of transmission as the second connection route.

12. The network connection method of claim 8, wherein the router is connected to the client computer through at least two transmission routes, and the router is configured for testing each said transmission route in order to determine the quality of transmission through each said transmission route and for setting the transmission route with the highest quality of transmission as the first connection route and the transmission route with the second highest quality of transmission as the second connection route.

13. The network connection method of claim 9, wherein each said transmission route is an Ethernet cable, a power line in a power-line network, a coaxial cable, or a wireless network.

14. The network connection method of claim 10, wherein each said transmission route is an Ethernet cable, a power line in a power-line network, a coaxial cable, or a wireless network.

15. The network connection method of claim 11, wherein each said transmission route is an Ethernet cable, a power line in a power-line network, a coaxial cable, or a wireless network.

16. The network connection method of claim 12, wherein each said transmission route is an Ethernet cable, a power line in a power-line network, a coaxial cable, or a wireless network.
